(19) United States
(12) Patent Application Publication
(10) Pub. No.: US 2018/0364352 A1
(43) Pub. Date: Dec. 20, 2018

(54) Safety System Having Surrounding Object Pattern for Vehicle

(71) Applicants: Horng-Huei TSENG, Hsinchu City (TW); Kuo-Ching CHIANG, New Taipei City (TW)

(72) Inventors: Horng-Huei TSENG, Hsinchu City (TW); Kuo-Ching CHIANG, New Taipei City (TW)

(21) Appl. No.: 15/627,413

(22) Filed: Jun. 19, 2017

(51) Int. Cl. G01S 13/93; G01S 7/06; G08G 1/0968

(52) U.S. Cl. CPC G01S 13/931; G01S 7/06; G01S 2013/9332; G08G 1/0968; G01S 13/93

(57) ABSTRACT

The present invention discloses a safety system for a user vehicle including a controller, a display, an inter-vehicle wireless communication module coupled to the controller to receive GPS data of other vehicle around the user vehicle. A surrounding object pattern generator is coupled to the controller to generate a surrounding object pattern based on the GPS data of the other vehicle.

### TECHNICAL FIELD

The present invention relates to a safety system of a vehicle, particularly, to a vehicle having the GPS data of adjacent vehicle.

### BACKGROUND OF RELATED ARTS

Typically vehicle uses the rearview mirror to monitor the rear view or the traffic condition. The driver has to turn his head to the left rearview mirror or the rights rear view mirror to check the traffic situation, frequently. However, there are blind spots that cannot be seen from the driver position. Further, during conditions of rainfall, the moisture or fog on the windshield may reduce the visible conditions. It will lead to the traffic accident. Unfortunately, there is no efficient way to sole the problem at present. Additionally, traffic conditions may vary rapidly. As a result, during such conditions, the driver must frequently remove the moisture by manual, which can be cumbersome. Current solution includes a magneto-resistive sensor located on a vehicle, upon sensing an object generates an object detection signal. However, the warning system cannot provide the actual situation to the driver.

Therefore, what is desired is to provide an improved blind-spot warning system. The improved system may increase reaction time and decrease the probability of a collision, efficiently.

### SUMMARY

In one aspect of the invention, the present invention discloses a safety system for a user vehicle including a controller, a display, an inter-vehicle wireless communication module coupled to the controller to receive GPS data of other vehicle around the user vehicle. A surrounding object pattern generator is coupled to the controller to generate a surrounding object pattern based on the GPS data of the other vehicle, wherein the surrounding object pattern is displayed on the display. The GPS data of the other vehicle is fetched by a vehicle-vehicle communication network. Alternatively, the vehicle-vehicle communication network includes vehicular ad hoc networks. The GPS data of the other vehicle is fetched by a satellite. The surrounding object pattern includes a user vehicle icon and a surrounding vehicle icon. The system further includes a warning system coupled to the controller to issue a first warning when the other vehicle enters into a first danger zone of the surrounding object pattern. The surrounding object pattern includes a second danger zone, the warning system coupled to the controller to issue a second warning when the other vehicle enters into the second danger zone of the surrounding object pattern. The surrounding object pattern indicates a distant between the other vehicle and the user vehicle on the display, and indicates a direction of the other vehicle relative to the user vehicle on the display. In one case, the surrounding object pattern is incorporated into an electronic map on the display.

In one aspect of the invention, a security system with rear view sensor for a vehicle includes a controller; a rear view sensor coupled to the controller and set external of the side panel of the vehicle to capture a rear view image to act the function of external rearview mirror, wherein the controller receives the signal from the rear view sensor. At least one display is coupled to the controller to display the rear view image, and a storage medium is coupled to the controller to store image data. The system further comprises a side view sensor coupled to the controller and set the surface of the vehicle to capture an image within the blind spot of the vehicle, the at least one display is coupled to the controller to display the image within the blind spot and the rear view sensor includes a night vision mode.

A safety system with a front view sensor for a vehicle comprises a controller, a front view sensor coupled to the controller to capture a front view sensor and set at front portion of the vehicle to capture a front image of the vehicle during the vehicle moving forwardly, wherein the controller receives the signal from the front view sensor, wherein the front view sensor is located near the front of the vehicle; at least one display is coupled to the controller to display the front view image during moving forwardly; and a storage medium coupled to the controller to store image data.

A further aspect of the present invention is a security system with an accident recording system for a vehicle comprising a controller; a plurality of sensors are coupled to the controller to capture the rear, the side or the front view image of car accident, wherein the controller receives the signal from the plurality of sensors; and an accident storage medium is coupled to the controller to store accident information and image data of the car accident. The system further comprises a communication module coupled to the controller to transmit the car accident image data in the accident storage medium, the accident information includes date and/or location.

### BRIEF DESCRIPTION OF THE DRAWINGS

FIG. 1 is a top diagrammatic view of the vehicle in accordance with the present invention.

FIG. 2 shows top diagrammatic view of the vehicle in accordance with the present invention.

FIG. 3 is the security system with surrounding vehicle pattern in accordance with the present invention.

FIG. 4 illustrates the embodiment in accordance with the present invention.

FIG. 5 is the security system with surrounding vehicle pattern in accordance with the present invention.

FIG. 6 illustrates alternative embodiment in accordance with the present invention.

### DETAILED DESCRIPTION OF THE INVENTION

In the following figures the same reference numerals will be used to illustrate the same components. While the present invention is described with respect to a particular method and apparatus for security system with blind-spot warning, various adaptations will be evident to those skilled in the art. Hereinafter, preferred embodiments of the present invention will be described in detail with reference to the accompanying drawings.

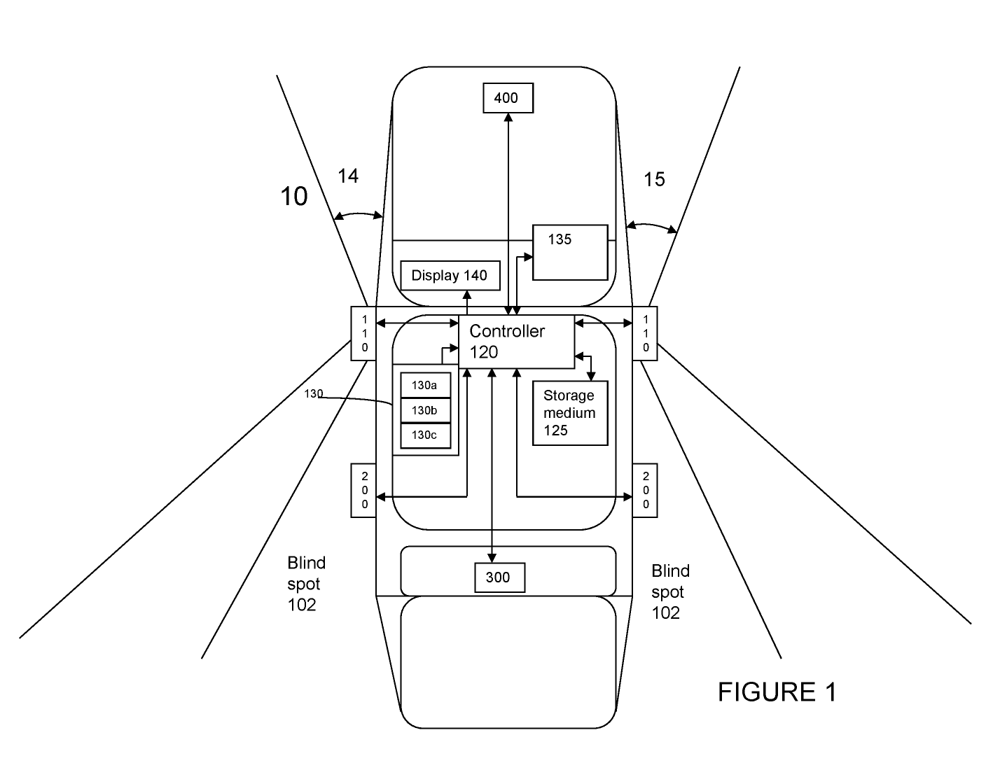

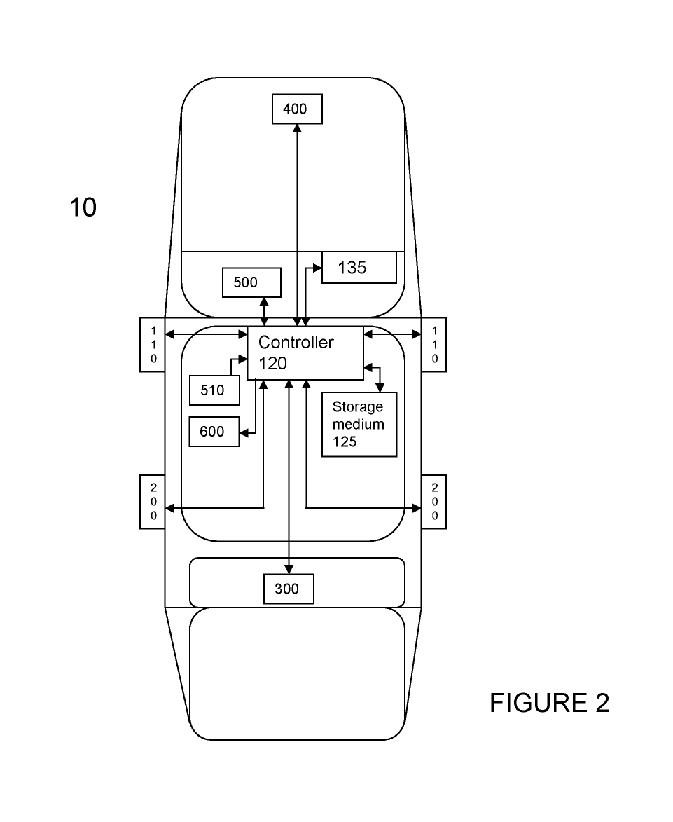

Referring now to FIGS. 1 and 2, the vehicle 10 includes a visual safety system, in accordance with one embodiment of the present invention, is illustrated. Representations of blind spots 102, 14 and 15 are illustrated. The blind spots 102 are the areas beyond which the conventional external rear-view mirrors cannot see without requiring the driver to glance back. The blind spots 102, 14, 15 areas may be changed depending on the mirror size and viewing angle of the driver. One aspect of the present invention is that the vehicle 10 includes at least two image sensors or video camera (such as digital video camera) 110 located on the original rearview mirrors location of the vehicle. In one preferred embodiment, the two rearview image sensors or video camera 110 could replace the function of the conventional rearview mirrors.

Referring now to FIG. 1, a block diagram of the system is illustrated. The system includes controller 120 processing signals from the vehicle image sensor. The digital external rearview image sensors 110 according to this embodiment comprise a CCD (charge couple device imaging means) or CMOS image sensor for imaging a still or motion picture image and are coupled to the processor. A storage medium 125 that stores still or motion picture image data obtained by the imaging sensor 110 is coupled to the processor 120. The storage medium 125 includes but not limited to hard disc, semiconductor memory, flash drive, flexible disk (such as memory card) or the combination thereof. An operation interface 130 comprising a shutter button 130a and an operation switch group 130b. The operation switch group 130b comprises buttons including a playback switch, recording switch and zoom-in and zoom-out switches. The function is provided to allow the driver or user to zoom-in or zoom-out the displayed image caught by the CCD or CMOS sensor. These functions are well-known in the field of digital video. A wireless inter-vehicle communication module 135 is used for establishing communication with external vehicles. The processor 120 could be GPU, CPU for centrally controlling respective sections of the digital video system of the vehicle 10. A switch 130c is provided to active the wireless inter-vehicle communication module 135.

One or more display 140 is connected to internal parts of the vehicle by a connecting member. The one or more display 140 could be set on the driving platform of the vehicle and in front of the driver but will not cause the visibility barrier of the diver. The operation interface 130 could be set on the platform or attached on the steering wheel of the vehicle 10. In one embodiment the connecting member for connecting the display to the main body of the vehicle may be a hinged structure that allows the display to be folded at any desired angle, or a universal joint structure that allows the display to be rotated three dimensionally, freely. The display 140 could be LCD display panel, PDP (plasma display panel) and organic electroluminescence (OLED) display panel. Other type of display could be used such as FED display panel.

In addition, the display 140 is rotatable and connected to the main body of the vehicle 10, so that the display 140 may be placed in a position that is easily viewable to the driver regardless of user position. Furthermore, the display 140 may display the rearview image in response to the operating of the rearview image sensor 110. Therefore, the rearview image sensor 110 may catch the image and send it to the display 140 regardless of the moisture or fog situation. Furthermore, the display 140 may be the OLED or FED that could be formed on the windshield of the vehicle.

The rearview (or front view) image sensors 110 could be set around the convention rearview mirror location, or they may replace the traditional rearview mirror location. It means that the rearview image sensors 110 are attached front portion of the front door adjacent to the front door glass. Preferably, a motor driver is coupled to the rearview image sensors 110 for allowing the user to adjust the direction and angle of the rearview image sensors 110. It could be adjusted to a suitable position to monitor the condition of the blind-spot areas 14 and 15.

The wireless inter-vehicle (vehicle to vehicle) communication module 135 has communication functions and capability to communicate with others vehicles around or surrounding the user vehicle. The safety system may be employed for exchange audio, text and/or video data with others vehicles. In addition, it may transmit and receive image data, etc. through a packet transmission facility to a remote terminal. Further, it may display the current geographical position of the vehicle by GPS device 510 in the cars. The operation interface includes a button 130c to active the wireless inter-vehicle communication module 135.

The system according to this embodiment uses storage medium 125 so that the user may access to the desired image data in the storage medium 125. Next, the operation of the image sensor constructed in the aforementioned manner will be described hereinafter. All of the sensors according to this embodiment switch imaging between still and motion picture images based on the duration of time for which the shutter button 130a is pressed down. For example, the CPU or GPU drives the image sensor to obtain a still image and store it on the storage medium 125. In normal operation, the CPU or GPU drives the CCD or CMOS sensor to start obtaining motion picture image data and display it on the display, and/or store it on the storage medium 125 depending on the demand of the user.

The rear rearview image sensor 300 is similar to the side rearview image sensor. It is used to provide rear view of the vehicle and used to perform (or replace) the function of the conventional internal rearview mirror. Various locations near the rear of the vehicle 10 including the trunk lid, the tailgate, the bumper, a rear portion of the roof may all be desirable locations for the sensors 300.

The vehicle 10 also includes at least two side warning sensor 200 attached on the side body of the vehicle to monitor the traffic situation of the blind spots 102. As aforementioned, the blind spots 102 are the areas beyond which the conventional external rear-view mirrors cannot see without requiring the driver to glance back. In one embodiment, the sensors comprise radar, IR detector, a CCD (charge couple device imaging means) or CMOS image sensor for detecting or imaging a still or motion picture image and are coupled to the processor 120.

The side warning sensors 200 receive proximity information from blind spots 102. A top view of the sensors 200 is illustrated in FIG. 1. Both sensors 200 are embodied as active or passive. If the sensor 200 is passive, it could be radar to detect the nearby vehicle in the blind spots area 102. In active case, the sensor could be an image sensor 200. The switch of the turn signal light is coupled to the image sensor 200, when the driver turn on the switch to turn on the turn signal for the purpose of, for example, changing lane or turning right or left, the switch will simultaneously active the side warning sensors 200 to shoot the view of the blind spots area 102 to allow the driver may check the traffic situation.

The image taken by the side warning sensors 200 could be sent to the display on real time. Alternatively, the side warning sensors 200 could be power on during the driving operation. The sensors 200 make use of image capturing capability or reflection signal changes when target vehicles pass within close proximity of the vehicle. The changes are received in the controller to determine the properties of the target vehicle's motion. In one embodiment, the sensors comprise radar, IR detector, a CCD or CMOS image sensor for detecting or imaging a still or motion picture image and are coupled to the processor 120.

The blind-spot warning sensor 200 provides an indication to the vehicle driver as to the entering of a target vehicle within at least one of the blind-spots. The present system includes a vehicle bus for receiving various vehicle control signals, when the sensor receives proximity information. The sensors 200 sense object or vehicle that is approaching the vehicle 10 on the passenger side and eventually entering into one of the blind-spots. The vehicle 10 includes two side sensors 200 having respective fields of view. The fields of view may not overlap or may slightly overlap blind-spots. Therefore, the present invention also monitors the transition from the sensor fields of view to the blind-spots. Current technology allows small sensors to be placed inconspicuously on rear panels of the vehicle so as not to become aesthetically displeasing. Various locations near the rear of the vehicle 10 including the trunk lid, the tailgate, the bumper, an area above the tires, an area within vehicle side panels, or a rear portion of the roof may all be desirable locations for the sensors 200.

Referring now to FIG. 1, a block diagram of the system is illustrated. The system includes an external front (view image) sensor 400 according to one of the embodiments. In one embodiment, the front sensor comprise radar, IR detector, a CCD or CMOS image sensor for detecting or imaging a still or motion picture image and are coupled to the processor 120. The storage medium 125 may store still or motion picture image data obtained by the imaging sensor 400. The operation interface 130 further comprises a night vision mode button 130c to active night vision mode, such as IR mode, of the front view image sensors 400 for providing better night vision. The display (or warning device) 140 is also coupled to the front (view image) sensors 400 to issue an alarm signal when an object is detected within a predetermined range.

Each one of the aforementioned sensor and the storage medium may record the digital motion picture or still image. It may provide the evidences of fact when traffic accidence occurs, and it could be employed as the “vehicle accidence black box” due to the system records the detail of what happen. A buffer having sufficient capacity for storing the motion picture image data is provided between the sensors and the storage means, and the motion picture data obtained by the sensors is stored on the storage means through the buffer. The CPU or GPU 120 is adapted to drive CCD or CMOS sensor to initiate imaging a motion picture image and store the data in the buffer from the time when the shutter button 130a is pressed down. As was mentioned, the system includes the sensors for detecting or imaging blind spot areas 102, 14 and 15, rear view, side view and front image and proximity information. The vehicle bus receives various vehicle control signals and the controller 120 processes signals from the vehicle bus and the sensors.

The CPU or GPU 120 is adapted to drive at four sides CCD or CMOS sensor to initiate imaging a motion picture image and store the data in the buffer. The system includes the sensors for imaging rear view, left-side view, right-side view, and front image. The vehicle bus receives various vehicle control signals and the controller 120 processes signals from the vehicle bus and the sensors. The four side views may be composition by a panoramic image module 600A and the GPU 120, followed by generating the panoramic image and displaying the panoramic image on the display.

Please refer to FIG. 2 of the present invention, anyone who opens the door without authority or breaks into the vehicle illegally, the control 120 will be active to control a panoramic image generating module 600A to create an panoramic image or video by at least four aforementioned image sensors, followed by displaying the panoramic image or video on the display 140. Preferably, an eye sensor 510 is coupled to the controller 120. The pressure sensor 510 may sensor the change of the eye (pupil) image of the vehicle driver. When the pupil change detected by the sensor 510 exceeds over a threshold, the sensor 510 will send a signal to the controller 120. The changes are received in the controller 120 to determine the situation of lane change. For instant, if the driver check the rearview mirror for a time threshold (for example, over 1 second), it means that the driver would like to change the lane, the safety system will turn on the turning signal light corresponding to the rear mirror which side the driver looks at. The sensor 510 is effective. The controller 120 implements advanced algorithms for processing signals from the vehicle bus and the sensors. The controller 120 is preferably a microprocessor-based controller having a central processing unit, internal memory such as RAM or ROM, and associated inputs and outputs communicating across the bus. The controller 120 may include various processing units which may be incorporated as separate devices or as an integral part of the controller. The warning system 600 is in responsive to the sensor 510 to issue a warning alarm.

As aforementioned, the present invention may detect the traffic condition including the blind spots area 102, 14, 15, front object for the driver. The vehicle interface or vehicle warning interface receives signals from the controller 120 and activates vehicle pre-crash warning systems 600 including, for example, audible warnings from the speaker, visual warnings or voice warnings before crash from a pre-crash warning system. All of the sensors including the rear view sensor, side view sensor, burglarproof sensor and the front view sensor include a night vision mode for operation in low light or darkness environment.

The eye detecting sensor may be replace or incorporated with EEG (electroencephalograph), Electromyographic (EMG) system. The warning system could be controlled and through the measurement of the electrical activity of the human brain. The EEG (electroencephalograph) records the voltage fluctuations of the brain which can be detected using electrodes attached to the scalp. The EEG signals arise from the cerebral cortex, a layer of highly convoluted neuronal tissue several centimeters thick. Alpha waves (8-13 Hz) that can be effected if the user concentrates on simple mentally isolated actions like closing one's eyes; Beta waves (14-30 Hz) associated with an alert state of mind; Theta waves (4-7 Hz) usually associated with the beginning of sleep state by frustration or disappointment; and Delta waves (below 3.5 Hz) associated with deep sleep. Electromyographic (EMG) sensors are attached to the person's skin to sense and translate muscular impulses to control computer functions. Patients have been reported to have moved objects on computer screens via EMG sensed tensing and untensing of facial muscles. Also Electrooculargraphic (EOG) signals have been sensed from eye movement. The neural activity is tracked on neural activity detecting device 350. Preferably, the neural activity tracked includes EEQ EOG EMG activity. The electrical signals representative of the neural activity are transmitted via wired or wireless to the control unit. If a predetermined signal is sensed by detecting device 510, the same EEG readings may be monitored. For example, the Theta wave (3.5-7 Hz.) is detected, it refers to the state of sleep. Thus, if the sleep pattern is detected, the warning system is responsive to the signal and issue an alarm to awake up the driver. It should be noted that the sleep patterns of potential users may be monitored before the system is used. The monitoring of and response to the user's facial expressions may also be used, for example, the closure of user's eyes could be monitored with a still camera or a video camera. These implementations could be in response to a signal that the user has passed into sleep.

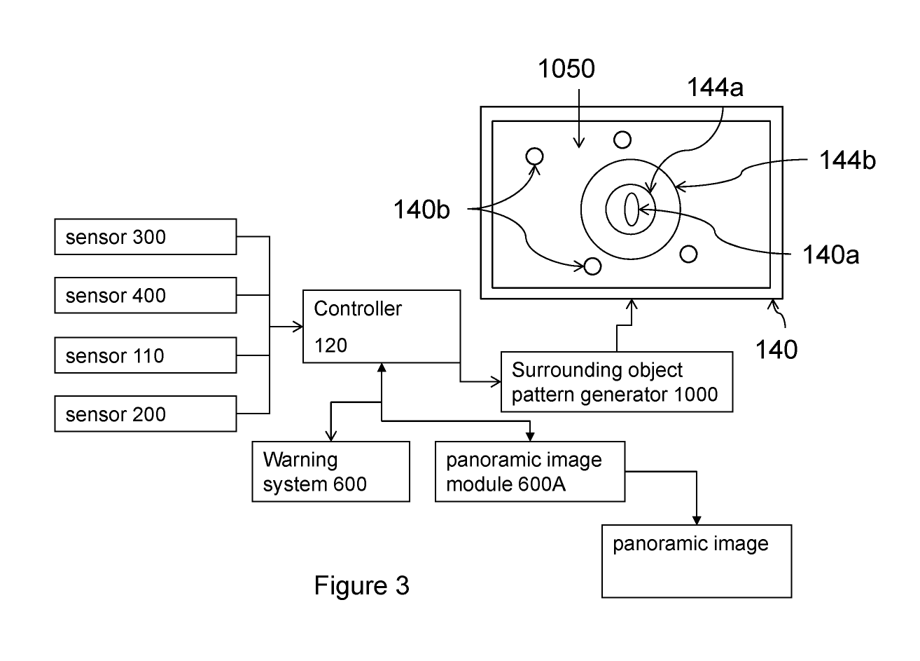

Please turning to FIG. 3, the present invention includes a surrounding object (target) pattern generator 1000 coupled to the controller 100. The detected signals from at least four sensors around four sides of the vehicle are fed into the controller 100. The detected signals include the information of the distant of the detected object (such as other vehicle) to the user vehicle, and the direction (angle) of the detected object to the user vehicle. Therefore, the surrounding object (target) pattern generator 1000 may generate a surrounding target pattern 1050 based on the fed distant and the direction information, followed by displaying the pattern on the display 140. The surrounding object (target) refers to the vehicles surrounding the user vehicle. The surrounding target pattern includes the user oneself vehicle icon 140a and other detected vehicle icons 140b. The distant and the direction of other vehicle may be shown on the display 140. The surrounding target pattern 1050 also indicates the first danger zone 144a and the second danger zone 144b. If other vehicle enters into the first danger zone 144a or the second danger zone 144b, the warning system 600 will be triggered by the controller 100.

A safety system for a user vehicle includes a controller, a display and at least four sensors coupled to the controller to detect a distant and a direction of other vehicle around the user vehicle. A surrounding object pattern generator 1000 is coupled to the controller to generate a surrounding object pattern based on the distant and the direction, and displaying the surrounding pattern on the display 140. The surrounding object pattern includes a user vehicle icon and a surrounding vehicle icon. The surrounding object pattern includes a first danger zone. A warning system is coupled to the controller to issue a warning when the other vehicle enters into the first danger zone. A wireless inter-vehicle communication module 135 is coupled to the controller to transmit geography data, image data, audio data, text data from other vehicle to a storage medium 125 of the user vehicle.

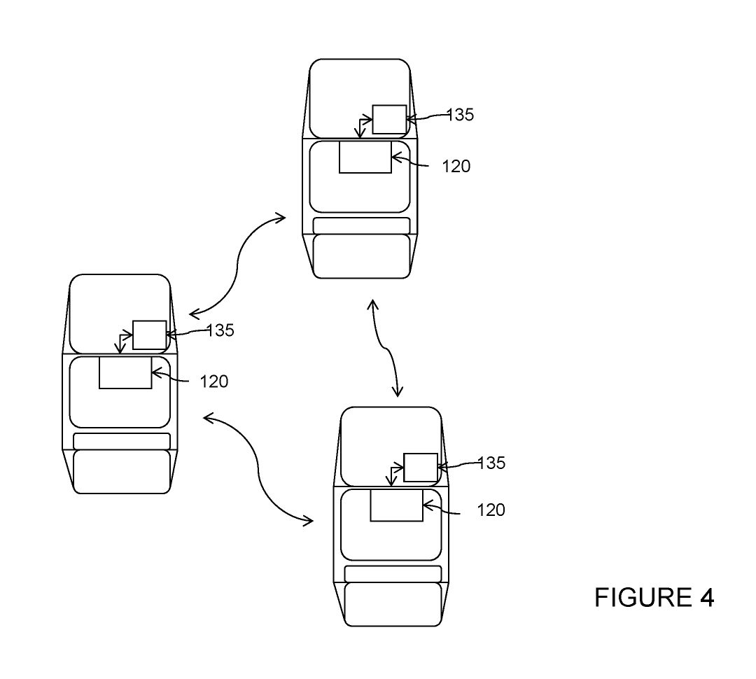

The storage medium 125 is coupled to the controller to store information and data when the other vehicles enter into the danger zone defined by the surrounding object pattern. The GPS 510 is provided for determining the position of the user vehicle. The GPS data of other vehicle is received by wireless inter-vehicle communication module 135. The warning system is coupled to the controller to issue a warning when the other vehicle enters into the danger zone. In one example, the pluralities of inter-vehicle wireless communication module 135 of several cars construct a vehicular ad-hoc network, please refer to FIG. 4. The vehicular ad hoc networks or inter-vehicle communication network are created by applying the principles of mobile ad hoc networks for the spontaneous creation of a wireless network for data exchange to the domain of vehicles. In one embodiment, the vehicular ad hoc networks or inter-vehicle communication network could employ the LTE (Long Term Evolution) protocol or others 5th generation mobile networks or 5th generation wireless systems. In addition to providing simply faster speeds, 5G networks meet the need of the internet of vehicles. It was provides vehicle-to-vehicle communications to provide road safety, navigation, and other roadside services.

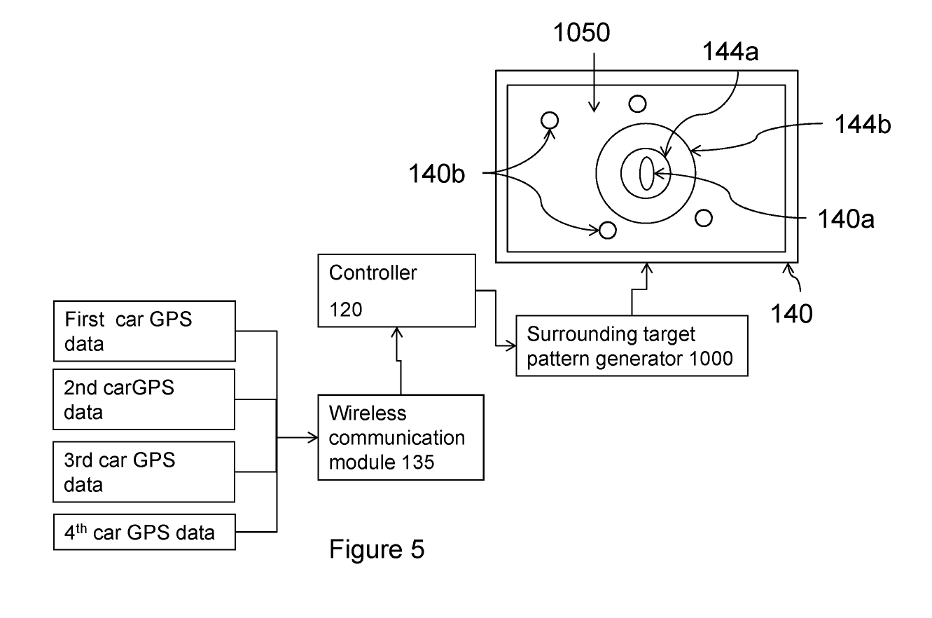

By employing the system, the drivers may exchange the position information fetched by GPS with one another. Please turning to FIG. 5, the present invention includes the surrounding object (target) pattern generator 1000 coupled to the controller 100. The fetched GPS data from other surrounding cars around the vehicle are fed into the controller 100 through the inter-vehicle wireless communication module 135. The GPS signals include the information of the geography information of other surrounding vehicles, and the relative position between the user own vehicle and other vehicle can be measured by the controller, for example, the direction, distant, angle of the detected object to the user own vehicle can be measured. Therefore, the surrounding target pattern generator 1000 may generate a surrounding target pattern 1050 based on the fed distant and the direction information, followed by displaying the pattern on the display 140. The surrounding target pattern includes the user oneself vehicle icon 140a and other detected vehicle icons 140b. The distant and the direction of other vehicle may be shown on the display 140.

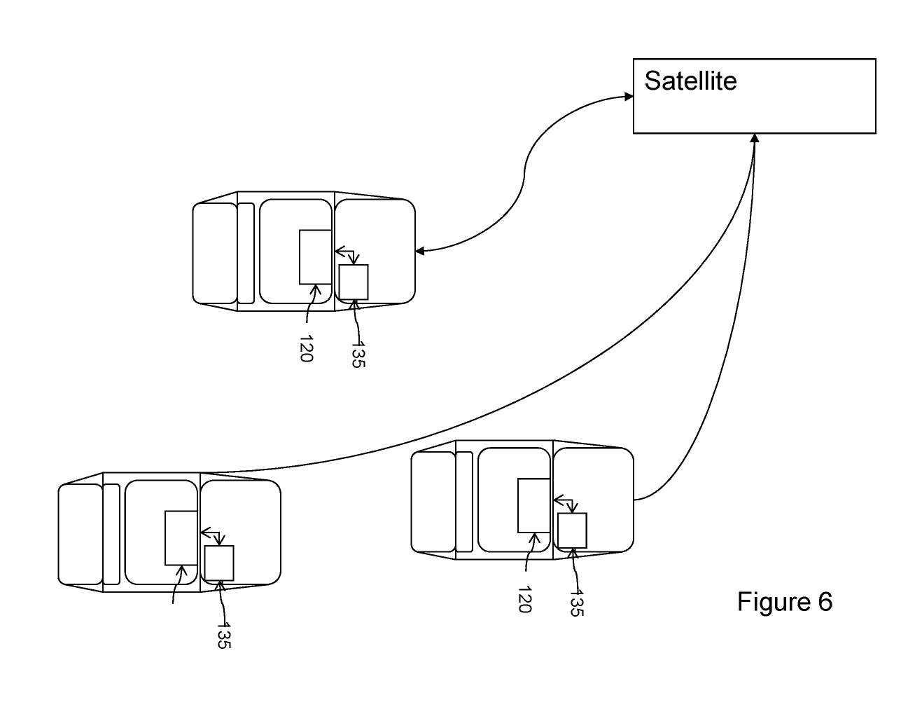

The surrounding target pattern 1050 also indicates the first danger zone 144a and the second danger zone 144b. If other vehicle enters into the first danger zone 144a or the second danger zone 144b, the warning system 600 will be triggered by the controller 100. Alternatively, the controller 100 of the system may allow the user to change the lane if other cars are not present within the danger zone. Otherwise, the warning system 600 will be triggered. Please refer to FIG. 6, another method to fetch the GPS data of other vehicles is to employ the satellite for transmitting the GPS data of other surrounding vehicles from satellite the through the GPS reception of the user own vehicle. The GPS data of other surrounding vehicles are determined by the satellite, and the GPS data of other surrounding vehicles is transmitted from the satellite to the user own car and received by the GPS 510 of the user car.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

1. A safety system for a user vehicle, comprising:
a controller;
a display;
a GPS receiver to receive a first GPS data of said user vehicle;
a 5th generation mobile module coupled to said controller to receive a second GPS data of other vehicle and transmit said first GPS data to said other vehicle; and
a surrounding object pattern generator coupled to said controller to generate a surrounding object pattern on said display based on said second GPS data of said other vehicle.

2. The system of claim 1, further comprising a vehicle-vehicle communication network coupled to said controller.

3. The system of claim 2, wherein said vehicle-vehicle communication network includes vehicular ad hoc networks.

4. The system of claim 1, further comprising a GPS to receive GPS data of said user vehicle.

5. The system of claim 1, wherein said surrounding object pattern includes a user vehicle icon and a surrounding vehicle icon.

6. The system of claim 1, further comprising a warning system coupled to said controller to issue a warning when said other vehicle enters into a danger zone of said surrounding object pattern.

7-9. (canceled)

10. The system of claim 1, wherein said surrounding object pattern indicates a direction of said other vehicle relative to said user vehicle on said display.

11. (canceled)

12. A safety system for a user vehicle, comprising:
a controller;
a display;
sensors formed at four sides of said user vehicle;
a panoramic image module coupled to said controller to generate a panoramic image based-on four sides views of said user vehicle imaging by said sensors;
a GPS receiver coupled to said controller to receive a first GPS data of said user vehicle;
a 5th generation mobile module coupled to said controller to receive a second GPS data of other vehicle and transmit said first GPS data to said other vehicle; and
a surrounding object pattern generator coupled to said controller to generate a surrounding object pattern on said display based on said first and said second GPS data of said other vehicle.

13. The system of claim 12, a further comprising vehicle-vehicle communication network coupled to said controller.

14. The system of claim 13, wherein said vehicle-vehicle communication network includes a vehicular ad hoc networks.

15. The system of claim 12, wherein said surrounding object pattern includes a user vehicle icon and a surrounding vehicle icon.

16. The system of claim 12, further comprising a warning system coupled to said controller to issue a warning when said other vehicle enters into a danger zone of said surrounding object pattern.

17-18. (canceled)

19. The system of claim 12, wherein said surrounding object pattern indicates a direction of said other vehicle relative to said user vehicle on said display.

20. The system of claim 12, wherein said surrounding object pattern is incorporated into an electronic map on said display.

21. A safety system for a user vehicle, comprising:
a controller;
a 5th generation mobile module coupled to said controller to receive a first GPS data of other vehicle;
a GPS fetching device coupled to said controller to receive a second GPS data of said user vehicle; and
an eye sensor coupled to said controller to sense change of a pupil image of said user vehicle driver, wherein said user vehicle changes lane based on said change of said pupil image.

22. The system of claim 21, wherein a lane change is determined by said controller.

23. The system of claim 21, further comprising a surrounding object pattern generator coupled to said controller to generate a related position of a surrounding object based on said GPS data of said other vehicle, wherein said related position includes direction and distant between said user vehicle and said other vehicle.

24. The system of claim 21, further comprising a vehicle-vehicle communication network.

25. The system of claim 24, wherein said vehicle-vehicle communication network includes a vehicular ad hoc networks.

26. The system of claim 21, further comprising an inter-vehicle wireless communication module coupled to said controller to receive data of other vehicle around said user vehicle.
